(19) United States
(12) Patent Application Publication
(10) Pub. No.: US 2025/0371803 A1
(43) Pub. Date: Dec. 4, 2025

(54) METHOD FOR MAP CREATION AND HOST

(71) Applicant: HTC Corporation, Taoyuan City (TW)

(72) Inventor: WanLing Yang, Taoyuan City (TW)

(73) Assignee: HTC Corporation, Taoyuan City (TW)

(21) Appl. No.: 18/976,354

(22) Filed: Dec. 11, 2024

Related U.S. Application Data
(60) Provisional application No. 63/655,086, filed on Jun. 3, 2024.

(51) Int. Cl. G06T 17/05; G06T 15/20; G06T 19/00

(52) U.S. Cl. CPC G06T 17/05; G06T 15/20; G06T 19/003

(57) ABSTRACT

Provided are a method for map creation and a host. The method includes: reading a digital environment model corresponding to a real-world scene; determining a movement path of a virtual tracking device within the digital environment model; determining a plurality of poses that realize the movement path within the digital environment model; rendering a plurality of viewpoint images based on the plurality of poses, wherein the plurality of poses respectively correspond to the plurality of viewpoint images, and each of the plurality of viewpoint images corresponds to a viewpoint from which the virtual tracking device captures the digital environment model when presenting the corresponding pose; and creating a spatial map corresponding to the real-world scene based on the plurality of viewpoint images.

### CROSS-REFERENCE TO RELATED APPLICATION

This application claims the priority benefit of U.S. provisional application Ser. No. 63/655,086, filed on Jun. 3, 2024. The entirety of the above-mentioned patent application is hereby incorporated by reference herein and made a part of this specification.

### BACKGROUND OF THE INVENTION

### Field of the Invention

The disclosure relates to a mechanism for creating environmental information, and in particular, to a method for map creation and a host.

### Description of Related Art

In prior art, it is a very common application for a plurality of virtual reality (VR) players to experience the same reality service (such as a VR game) in the same scene (such as a room having specific furnishings, etc.).

In order to carry out the above application smoothly, a process of spatial map creation needs to be first performed in the scene via a certain tracking device, and then the tracking device shares the created map with the game device corresponding to each player (such as the head-mounted displays (HMDs) of other players).

For example, before starting to experience the reality service, a specific player may hold the HMD and move around in the scene. The HMD may perform a tracking technique such as Simultaneous Localization and Mapping (SLAM) as the specific player moves, thereby creating a spatial map (for example, a SLAM map) of the scene.

However, the method for spatial map creation not only consumes a lot of physical energy of the specific player, but the process is also quite time-consuming. For example, for a scene having an area of 30 m×10 m, it may take the specific player about 40 minutes to move around in this scene to create a suitable spatial map.

In addition, due to the greater differences in the way different players move around in the scene, the quality of the spatial map created may also be unstable.

### SUMMARY OF THE INVENTION

Accordingly, the disclosure provides a method for map creation and a host that may be used to solve the above technical issues.

An embodiment of the disclosure provides a method for map creation executed by a host, including: reading a digital environment model corresponding to a real-world scene; determining a movement path of a virtual tracking device within the digital environment model; determining a plurality of poses that realize the movement path within the digital environment model; rendering a plurality of viewpoint images based on the plurality of poses, wherein the plurality of poses respectively correspond to the plurality of viewpoint images, and each of the plurality of viewpoint images corresponds to a viewpoint from which the virtual tracking device captures the digital environment model when presenting the corresponding pose; and creating a spatial map corresponding to the real-world scene based on the plurality of viewpoint images.

An embodiment of the disclosure provides a host including a storage circuit and a processor. The storage circuit stores a program code. The processor is coupled to the storage circuit and configured to access the program code to execute: reading a digital environment model corresponding to a real-world scene; determining a movement path of a virtual tracking device within the digital environment model; determining a plurality of poses that realize the movement path within the digital environment model; rendering a plurality of viewpoint images based on the plurality of poses, wherein the plurality of poses respectively correspond to the plurality of viewpoint images, and each of the plurality of viewpoint images corresponds to a viewpoint from which the virtual tracking device captures the digital environment model when presenting the corresponding pose; and creating a spatial map corresponding to the real-world scene based on the plurality of viewpoint images.

### BRIEF DESCRIPTION OF THE DRAWINGS

FIG. 1 is a schematic diagram of a host shown according to an embodiment of the disclosure.

FIG. 2 is a flowchart of a method for map creation shown according to an embodiment of the disclosure.

FIG. 3 is a top view of a digital environment model shown according to an embodiment of the disclosure.

FIG. 4 is a schematic diagram of a plurality of viewpoint images shown according to FIG. 3.

FIG. 5 is a schematic diagram of planning a movement path shown according to an embodiment of the disclosure.

FIG. 6 is a schematic diagram of a plurality of specified actions shown according to an embodiment of the disclosure.

FIG. 7 is a schematic diagram of a planned movement path shown according to FIG. 3 and FIG. 6.

### DESCRIPTION OF THE EMBODIMENTS

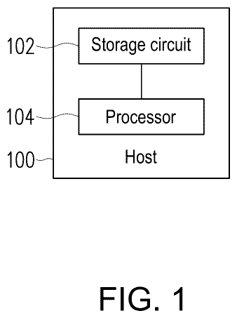

Please refer to FIG. 1. FIG. 1 is a schematic diagram of a host shown according to an embodiment of the disclosure.

In various embodiments, a host 100 may be any smart device and/or computer device capable of providing visual content of reality service, such as virtual reality (VR) service, augmented reality (AR) service, mixed reality (MR) service, and/or extended reality (XR) service, but the disclosure is not limited thereto. In some embodiments, the host 100 may be an HMD capable of displaying/providing visual content (for example, AR/VR/MR content) for a wearer/user to watch, but the disclosure is not limited thereto.

In FIG. 1, the host 100 includes a storage circuit 102 and a processor 104. The storage circuit 102 may be, for example, any type of fixed or removable random-access memory (RAM), read-only memory (ROM), flash memory, hard disk, or other similar devices, integrated circuits, or a combination of these devices, and may be used to record a plurality of program codes or modules.

The processor 104 is coupled to the storage circuit 102, and may be a general-purpose processor, a special-purpose processor, a conventional processor, a digital signal processor, a plurality of microprocessors, one or a plurality of microprocessors combined with digital signal processor cores, a controller, a microcontroller, an application-specific integrated circuit (ASIC), a field-programmable gate array (FPGA) circuit, any other type of integrated circuit, state machine, Advanced RISC Machine (ARM)-based processor, and the like.

In an embodiment of the disclosure, the processor 104 may access the modules and program codes recorded in the storage circuit 102 to implement the method for map creation provided in the disclosure, the details of which are described in detail below.

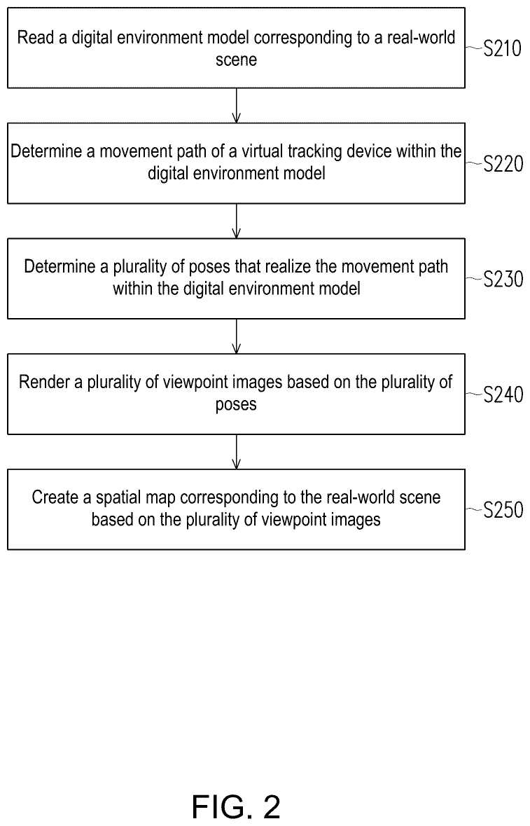

Please refer to FIG. 2. FIG. 2 is a flowchart of a method for map creation shown according to an embodiment of the disclosure. The method of the present embodiment may be executed by the host 100 of FIG. 1. The details of each step of FIG. 2 are described below with reference to the elements shown in FIG. 1.

In step S210, the processor 104 reads a digital environment model corresponding to a real-world scene.

In the present embodiment, the real-world scene is, for example, any real scene for which a spatial map (such as a SLAM map) needs to be created, such as a space to allow a plurality of players to experience real-world service therein together, such as various rooms, venues, etc., but the disclosure is not limited thereto.

In addition, the digital environment model is, for example, a 3D space model corresponding to the real-world scene. In an embodiment, the digital environment model may completely correspond to the real-world scene. For example, the arrangement, spatial proportion, color, light, and structure of the digital environment model may be exactly the same as the real-world scene.

In some embodiments, the digital environment model may also be called a digital twin of the real-world scene.

Broadly speaking, digital twins are a digital simulation technique used to create exact digital replicas of physical objects (such as the real-world scene above) or systems in a virtual environment. They are not only a static digital representation, but may also be dynamically updated to reflect the real-time status of physical objects, helping to monitor, simulate, and predict. Digital twins are composed of physical objects, digital models, data connections, and data analysis techniques, and may obtain real-time data via sensors for analysis to provide decision-making. Digital twins have a wide range of applications, covering industrial manufacturing (such as monitoring production processes, predicting equipment maintenance), urban planning (such as smart city management), medical health (such as human body system simulation), and automotive and aviation (such as performance analysis). Digital twins may deeply understand the operating status of physical systems and predict failure risks, thereby reducing costs, improving efficiency, and accelerating innovation.

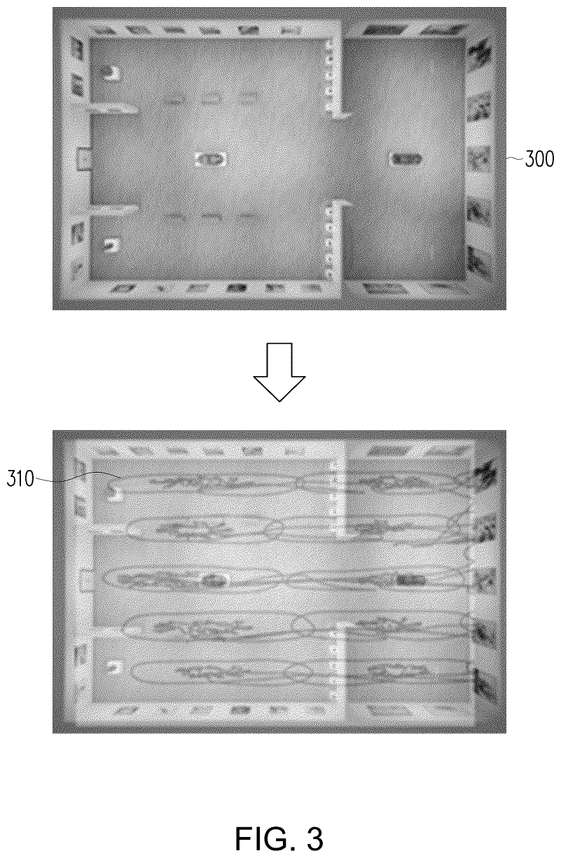

Please refer to FIG. 3. FIG. 3 is a top view of a digital environment model shown according to an embodiment of the disclosure.

In FIG. 3, for example, the processor 104 may read a digital environment model 300 in step S210, wherein the digital environment model 300 is, for example, a digital twin of a certain real-world scene, but the disclosure is not limited thereto.

Then, in step S220, the processor 104 determines a movement path 310 of the virtual tracking device in the digital environment model 300.

In an embodiment of the disclosure, the virtual tracking device is, for example, a virtual device that may execute a tracking technique in a virtual space such as the digital environment model 300 to realize the desired tracking function. In an embodiment, the virtual tracking device itself is virtual (such as a virtual HMD), and may exist in the digital environment model 300 to perform a related tracking technique (e.g., inside-out tracking and/or outside-in tracking).

In some embodiments, the virtual tracking device may be provided with a virtual tracking camera, wherein the virtual tracking camera may have an image capturing range, and the image capturing range may capture different portions in the digital environment model 300 in response to the pose of the virtual tracking device.

In some embodiments, the virtual tracking device may, for example, perform SLAM in the digital environment model 300 to create a spatial map corresponding to the digital environment model 300. In an embodiment of the disclosure, since the digital environment model 300 corresponds to the above real-world scene, the spatial map created by the virtual tracking device is also a spatial map corresponding to the above real-world scene.

In FIG. 3, the movement path 310 is, for example, a path when the virtual tracking device is simulated to move around in the digital environment model 300 to create a spatial map.

In some embodiments, in order to make the created spatial map more complete, the movement path 310 may be designed in a more complex manner, as shown in FIG. 3, but the disclosure is not limited thereto.

It should be understood that although the movement path 310 shown in FIG. 3 appears to simulate the movement trajectory of the virtual tracking device on a single plane, the actual movement path 310 may also involve behaviors such as multi-directional movement, multi-directional tilting, multi-directional rotation of the virtual tracking device, but the disclosure is not limited thereto.

In step S230, the processor 104 determines a plurality of poses that realize the movement path 310 in the digital environment model 300.

In an embodiment of the disclosure, the poses mentioned may be presented in the form of data with six degrees of freedom, for example. That is, each pose may include translation and rotation, but the disclosure is not limited thereto.

As mentioned before, the movement path 310 may actually involve behaviors such as multi-directional movement, multi-directional pitching, multi-directional rotation of the virtual tracking device, and these behaviors may all be represented by a series of corresponding poses. In other words, if the virtual tracking device is simulated to move according to the plurality of poses, the overall movement trajectory of the virtual tracking device in the digital environment model 300 may form the movement path 310, but the disclosure is not limited thereto.

In step S240, the processor 104 renders a plurality of viewpoint images based on the plurality of poses, wherein the plurality of poses respectively correspond to the plurality of viewpoint images, and each of the plurality of viewpoint images corresponds to a viewpoint from which the virtual tracking device captures the digital environment model 300 when presenting the corresponding pose.

For example, the plurality of poses may include an i-th pose (i is an index value), the plurality of viewpoint images may include an i-th viewpoint image corresponding to the i-th pose, and the i-th viewpoint image corresponds to a viewpoint from which the virtual tracking device captures the digital environment model 300 when presenting the corresponding i-th pose.

That is, when the virtual tracking device is simulated to present the i-th pose in the digital environment model 300, the virtual tracking camera of the virtual tracking device may be understood as capturing the digital environment model 300 from a certain viewpoint. That is, a certain portion of the digital environment model 300 is captured in the image capturing range of the virtual tracking device, and the image captured by the virtual tracking camera at this time may be understood as the i-th viewpoint image.

Since the behavior of the virtual tracking device is simulated by the processor 104, the processor 104 may present the i-th viewpoint image as the i-th pose at the virtual tracking device, and render the corresponding viewpoint image based on the i-th pose as the i-th viewpoint image, but the disclosure is not limited thereto.

Accordingly, for each pose determined in step S230, the processor 104 may render the corresponding viewpoint image according to the above teachings.

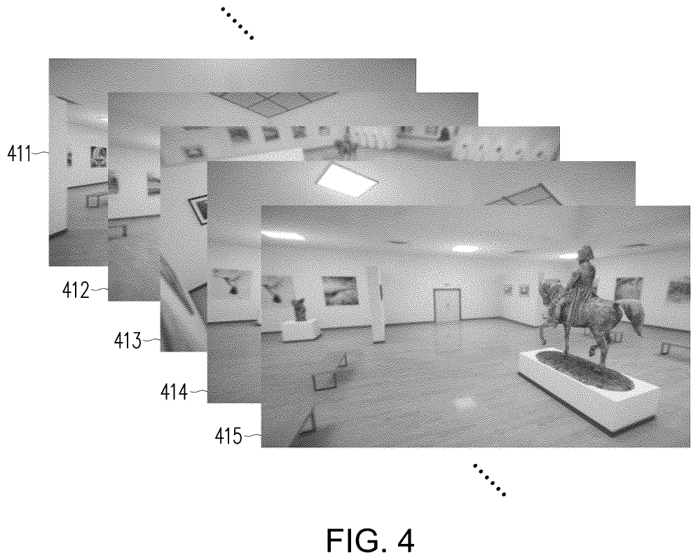

Please refer to FIG. 4. FIG. 4 is a schematic diagram of a plurality of viewpoint images shown according to FIG. 3.

In FIG. 4, a viewpoint image 411 to a viewpoint image 415 are, for example, viewpoint images respectively corresponding to five of the plurality of poses. For example, when the virtual tracking device is simulated to present a pose 1 in the digital environment model 300, the processor 104 may render the viewpoint image 411 accordingly; when the virtual tracking device is simulated to present a pose 2 in the digital environment model 300, the processor 104 may render the viewpoint image 412 accordingly; when the virtual tracking device is simulated to present a pose 3 in the digital environment model 300, the processor 104 may render the viewpoint image 413 accordingly; when the virtual tracking device is simulated to present a pose 4 in the digital environment model 300, the processor 104 may render the viewpoint image 414 accordingly; when the virtual tracking device is simulated to present a pose 5 in the digital environment model 300, the processor 104 may render the viewpoint image 415 accordingly.

It may be seen from the viewpoint image 415 that when the virtual tracking device is simulated to present the pose 5 in the digital environment model 300, the image capturing range of the virtual tracking device may capture doors, paintings, benches, statues, floors, lamps, etc., in the digital environment model 300, but the disclosure is not limited thereto.

In step S250, the processor 104 creates a spatial map corresponding to the real-world scene based on the plurality of viewpoint images.

In an embodiment, the processor 104 may perform SLAM based on the plurality of viewpoint images to create a spatial map (SLAM map) corresponding to the real-world scene.

Taking FIG. 4 as an example, after obtaining the viewpoint image 411 to the viewpoint image 415, the processor 104 can, for example, execute SLAM accordingly to determine information such as keyframes and/or map points in the SLAM map, but the disclosure is not limited thereto.

For example, the processor 104 may detect feature points from each viewpoint image and perform feature point matching on feature points in different viewpoint images. Then, the processor 104 may generate three-dimensional map points of the digital environment model 300 via triangulation.

During the execution of SLAM, the processor 104 may select and store key frames according to pose changes of the virtual tracking device or changes in the scene within the image capturing range, so as to reduce the computational burden and provide a stable relocation basis. Via these steps, the processor 104 applying SLAM may gradually build an accurate spatial map using different viewpoint images, and realize dynamic positioning and stable environment modeling, but the disclosure is not limited thereto.

Via the above technical means, the creation of spatial maps may be completed without consuming manpower. In addition, the quality stability of spatial maps may also be improved.

In some embodiments, the method of FIG. 2 may also be executed on a computing device (such as a personal computer, a server, etc.) having higher computing power. In this case, since these computing devices may render the plurality of viewpoint images with better efficiency, the time needed to create a spatial map may be effectively shortened.

In an embodiment, the host 100 (for example, the HMD of a player) and at least one other host (for example, the HMD of another player) are located in the real-world scene, and after creating a spatial map corresponding to the real-world scene, the processor 104 may share the spatial map corresponding to the real-world scene to the at least one other host, wherein the host 100 and the at least one host provide the same reality service.

That is, after the host 100 creates the spatial map via the method of FIG. 2, the host 100 may share the created spatial map with other hosts located in the same space/venue/room, so that these hosts may provide the same reality service using the same spatial map.

In another embodiment, the host 100 (e.g., a server) may share the spatial map corresponding to the real-world scene to the at least one other host after creating the spatial map corresponding to the real-world scene.

That is, in an embodiment of the disclosure, after the method of FIG. 2 is executed by a computing device (for example, a server) having higher computing power, the created space map may be shared with other hosts (such as HMDs of different players) located in the real-world space, but the disclosure is not limited thereto.

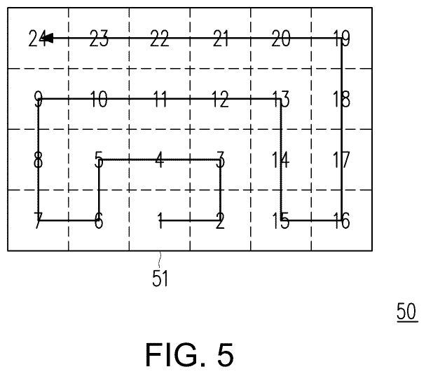

Please refer to FIG. 5. FIG. 5 is a schematic diagram of planning a movement path shown according to an embodiment of the disclosure.

In FIG. 5, for a digital environment model 50, the processor 104 may, for example, divide the digital environment model 50 into a plurality of blocks 51 (for example, blocks numbered 1 to 24 as shown), and plan a sequence through the plurality of blocks 51.

In the present embodiment, for example, the processor 104 may plan to sequentially pass through the blocks numbered 1 to 24 (indicated by the arrows shown), but the disclosure is not limited thereto.

In an embodiment of the disclosure, the plurality of blocks 51 includes a first block (for example, one of the blocks numbered 1 to 24), and the movement path includes a first path segment located in the first block. Moreover, the plurality of poses may include a plurality of first poses that realize the first path segment, and the plurality of first poses are used to simulate a plurality of specified actions performed sequentially by the virtual tracking device in the first block.

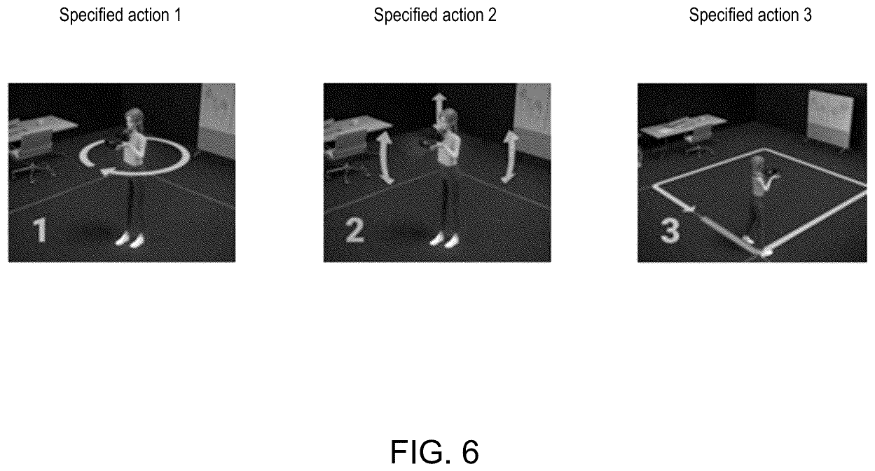

Please refer to FIG. 6. FIG. 6 is a schematic diagram of a plurality of specified actions shown according to an embodiment of the disclosure.

In FIG. 6, a specified action 1 is, for example, a user (such as the specific player mentioned earlier) located at a certain block holding a tracking device (such as an HMD) to rotate in place in the block. A specified action 2 is, for example, while holding the tracking device, the user rotating the tracking device up and down while rotating in place in the block. A specified action 3 is, for example, while holding the tracking device, the user detouring the block.

Accordingly, for the first path segment located in the first block, the processor 104 may simulate a plurality of specific poses corresponding to when the virtual tracking device is sequentially used to perform the specified action 1, the specified action 2, and the specified action 3 in the first block, and then the plurality of specific poses are used as a plurality of first poses that realize the first path segment, but the disclosure is not limited thereto.

For example, for the block numbered 1, the processor 104 may simulate a plurality of specific poses corresponding to when the virtual tracking device is sequentially used to perform the specified action 1, the specified action 2, and the specified action 3 in the block numbered 1, and then the plurality of specific poses are used as a plurality of poses that realize the path segment located in the block numbered 1.

As another example, for the block numbered 2, the processor 104 may simulate a plurality of specific poses corresponding to when the virtual tracking device is sequentially used to perform the specified action 1, the specified action 2, and the specified action 3 in the block numbered 2, and then the plurality of specific poses are used as a plurality of poses that realize the path segment located in the block numbered 2.

For other numbered blocks, the processor 104 may determine a plurality of poses corresponding to the path segments located at each block according to the above principles.

Then, the plurality of poses independently corresponding to the blocks numbered 1 to 24 may be integrated to form the movement path mentioned in step S220, but the disclosure is not limited thereto.

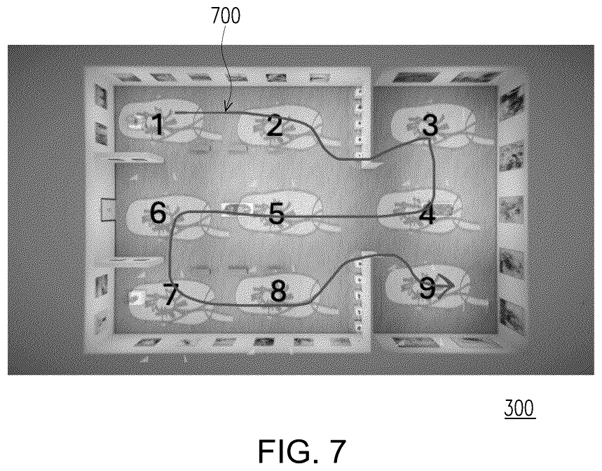

Please refer to FIG. 7. FIG. 7 is a schematic diagram of a planned movement path shown according to FIG. 3 and FIG. 6.

In the scenario of FIG. 7, the digital environment model 300 is divided into blocks numbered 1 to 9, and the virtual tracking device is assumed to sequentially simulate the movement patterns of the specified action 1 to the specified action 3 in each block, thereby forming a trajectory such as a movement path 700, but the disclosure is not limited thereto.

Based on the above, the method of map creation provided by an embodiment of the disclosure may simulate a plurality of poses presented by the virtual tracking device in the digital environment model, and render the corresponding viewpoint images, and then create a spatial map corresponding to the digital environment model and the real-world scene based on the rendered viewpoint images. In this way, a spatial map corresponding to the real-world scene may be created in a more labor-saving, time-saving, and stable manner.

Although the disclosure has been described with reference to the above embodiments, it will be apparent to one of ordinary skill in the art that modifications to the described embodiments may be made without departing from the spirit of the disclosure. Accordingly, the scope of the disclosure is defined by the attached claims not by the above detailed descriptions.

What is claimed is:

1. A method for map creation, executed by a host, comprising:
reading a digital environment model corresponding to a real-world scene;
determining a movement path of a virtual tracking device in the digital environment model;
determining a plurality of poses that realize the movement path in the digital environment model;
rendering a plurality of viewpoint images based on the plurality of poses, wherein the plurality of poses respectively correspond to the plurality of viewpoint images, and each of the plurality of viewpoint images corresponds to a viewpoint from which the virtual tracking device captures the digital environment model when presenting the corresponding pose; and
creating a spatial map corresponding to the real-world scene based on the plurality of viewpoint images.

2. The method of claim 1, further comprising:
dividing the digital environment model into a plurality of blocks, and planning a sequence through the plurality of blocks, wherein the plurality of blocks comprise a first block, the movement path comprises a first path segment located in the first block, the plurality of poses comprise a plurality of first poses that realize the first path segment, and the plurality of first poses are used to simulate a plurality of specified actions performed sequentially by the virtual tracking device in the first block.

3. The method of claim 1, wherein the plurality of poses comprise an i-th pose, the plurality of viewpoint images comprise an i-th viewpoint image corresponding to the i-th pose, and the i-th viewpoint image corresponds to a viewpoint from which the virtual tracking device captures the digital environment model when presenting the corresponding i-th pose, wherein i is an index value.

4. The method of claim 1, wherein creating the spatial map corresponding to the real-world scene based on the plurality of viewpoint images comprises:
performing simultaneous localization and mapping based on the plurality of viewpoint images to create the spatial map corresponding to the real-world scene.

5. The method of claim 1, wherein the host and at least one other host are located in the real-world scene, and after the spatial map corresponding to the real-world scene is created, the method further comprises:
sharing the spatial map corresponding to the real-world scene to the at least one other host, wherein the host and the at least one host provide a same reality service.

6. The method of claim 1, wherein after the spatial map corresponding to the real-world scene is created, the method further comprises:
sharing the spatial map corresponding to the real-world scene to at least one other host located in the real-world scene.

7. A host, comprising:
a storage circuit storing a program code; and
a processor coupled to the storage circuit and configured to access the program code to execute:
reading a digital environment model corresponding to a real-world scene;
determining a movement path of a virtual tracking device in the digital environment model;
determining a plurality of poses that realize the movement path in the digital environment model;
rendering a plurality of viewpoint images based on the plurality of poses, wherein the plurality of poses respectively correspond to the plurality of viewpoint images, and each of the plurality of viewpoint images corresponds to a viewpoint from which the virtual tracking device captures the digital environment model when presenting the corresponding pose; and
creating a spatial map corresponding to the real-world scene based on the plurality of viewpoint images.

8. The host of claim 7, wherein the processor is further configured to:
divide the digital environment model into a plurality of blocks, and plan a sequence through the plurality of blocks, wherein the plurality of blocks comprise a first block, the movement path comprises a first path segment located in the first block, the plurality of poses comprise a plurality of first poses that realize the first path segment, and the plurality of first poses are used to simulate a plurality of specified actions performed sequentially by the virtual tracking device in the first block.

9. The host of claim 7, wherein the plurality of poses comprise an i-th pose, the plurality of viewpoint images comprise an i-th viewpoint image corresponding to the i-th pose, and the i-th viewpoint image corresponds to a viewpoint from which the virtual tracking device captures the digital environment model when presenting the corresponding i-th pose, wherein i is an index value.

10. The host of claim 7, wherein the processor is configured to:
perform simultaneous localization and mapping based on the plurality of viewpoint images to create the spatial map corresponding to the real-world scene.

11. The host of claim 7, wherein the host and at least one other host are located in the real-world scene, and after the spatial map corresponding to the real-world scene is created, the processor is further configured to:
share the spatial map corresponding to the real-world scene to the at least one other host, wherein the host and the at least one host provide a same reality service.

12. The host of claim 7, wherein after the spatial map corresponding to the real-world scene is created, the processor is further configured to:
share the spatial map corresponding to the real-world scene to at least one other host located in the real-world scene.
